(19) United States
(12) Patent Application Publication
(10) Pub. No.: US 2025/0367632 A1
(43) Pub. Date: Dec. 4, 2025

(54) MULTISTAGE SERIES MICROREACTOR AND FLUID MIXING METHOD

(71) Applicants: ZHENGZHOU UNIVERSITY, Zhengzhou (CN); ZHEJIANG TAIZHOU PUDU INTELLIGENT EQUIPMENT CO., LTD, Taizhou (CN)

(72) Inventors: Wenpeng LI, Zhengzhou (CN); Guanghai WEI, Taizhou (CN); Zhirong YANG, Zhengzhou (CN); Jingtao WANG, Zhengzhou (CN); Jie ZHANG, Zhengzhou (CN); Guoli ZHOU, Zhengzhou (CN); Wenjia WU, Zhengzhou (CN); Xiaoli WU, Zhengzhou (CN)

(21) Appl. No.: 19/059,740

(22) Filed: Feb. 21, 2025

(30) Foreign Application Priority Data
May 30, 2024 (CN) 202410687264.2

(51) Int. Cl. B01J 19/00

(52) U.S. Cl. CPC B01J 19/0093; B01J 19/006; B01J 2219/0077; B01J 2219/0086; B01J 2219/00867; B01J 2219/00869; B01J 2219/00889; B01J 2219/00891

(57) ABSTRACT

The present invention relates to a multistage series microreactor and a fluid mixing method. The microreactor includes a base internally etched with a fluid passage, the base being provided with a fluid inlet and a fluid outlet which are communicated with the fluid passage, where the fluid passage includes a plurality of micro mixing tanks, a jet port is formed at an inlet of the micro mixing tank, adjacent micro mixing tanks are connected by jet port at a contraction section, and a splayed flow baffle plate and a flow splitting column which are arranged corresponding to the jet port are provided in the micro mixing tank, the flow splitting column being arranged below the splayed flow baffle plate. By means of a jet manner, a fluid to be mixed in the invention can be continuously split, compounded, stretched and crushed, thereby realizing rapid mixing and efficient, continuous reaction.

### CROSS-REFERENCE TO RELATED APPLICATION

This application claims the priority of Chinese patent application No. 202410687264.2, filed on May 30, 2024, which application is hereby incorporated herein by reference.

### TECHNICAL FIELD

The present invention belongs to the technical field of microreactors, and particularly relates to a multistage series microreactor and a fluid mixing method.

### BACKGROUND

As one of the important ways of chemical process intensification, the micro-chemical technology is an important way to achieve a safe, environment-friendly and efficient chemical process. A microreactor, as the core of the micro-chemical technology, is a reaction device with a microstructure, which is manufactured by means of the micromachining technology. The device has a feature size between several microns and hundreds of microns, exhibits remarkable advantages of controllable reaction time, good mixing effect, large specific surface area, high heat transfer and mass transfer efficiency, easy amplification, good safety performance and environmental protection due to its unique structure, macroscopic flow characteristics and transfer characteristics, and is widely used in various rapid mixing, emulsification, mass transfer, heat transfer and reaction processes.

At present, there are relatively few studies on the flow patterns in millimeter-scale microreactors. The most representative millimeter-scale microreactor is Corning Incorporated's Advanced-Flow Reactor, whose relatively large feature size significantly increases its processing capacity. However, with the increase of flow velocity, the intensified fluid turbulence will inevitably cause the formation of vortices, and the stagnation zone in the reactor will obviously expand, which leads to the uneven distribution of velocity and the formation of local hot spots. This not only affects the uniform distribution performance of fluids and mixing efficiency, but also widens the residence time distribution, thereby reducing the reaction conversion rate and production efficiency.

Therefore, it is very necessary to develop a novel microreactor structure to enhance the mixing process of fluids and improve the uniform distribution performance of fluids, realizing the rapid mixing and efficient reaction of various components.

### SUMMARY

Objectives of the present invention are to provide a multistage series microreactor and a fluid mixing method, so as to enhance the mixing process of fluids and realize continuous reaction. According to the present invention, by means of a jet manner, a fluid to be mixed is continuously split, compounded, stretched and crushed, so that the contact area is increased, and the uniform distribution performance of fluids is improved, thereby realizing rapid mixing and efficient reaction.

Based on one objective of the present invention, the technical solution proposed by the present invention is as follows:

a multistage series microreactor, including a base internally etched with a fluid passage, the base being provided with a fluid inlet and a fluid outlet which are communicated with the fluid passage, where the fluid passage includes a plurality of micro mixing tanks, a jet port is formed at an inlet of the micro mixing tank, adjacent micro mixing tanks are connected by the jet port, and a splayed flow baffle plate and a flow splitting column which are arranged corresponding to the jet port are provided in the micro mixing tank, the flow splitting column being arranged downstream the splayed flow baffle plate.

Preferably, in each micro mixing tank, the number of the splayed flow baffle plate is one pair, the splayed flow baffle plate is 0.5 to 1 mm away from a jet port at the top end of the micro mixing tank and has an opening angle of 25 to 45 degrees, the jet port being located on a central axis of the splayed flow baffle plate.

Preferably, the splayed flow baffle plate includes two baffle plates which are bilaterally symmetrical along the central axis of the splayed flow baffle plate, and the baffle plates are rectangular in cross section; the baffle plate has a width of 0.3 to 0.6 mm and a length of 3 to 6 mm; in each micro mixing tank, the central axis of the splayed flow baffle plate is 0.4 to 0.6 mm away from the top end of the baffle plate and 1 to 1.5 mm away from the bottom end of the baffle plate.

Preferably, the flow splitting column is cylindrical and has a diameter of 2.5 to 3.5 mm; in each micro mixing tank, an axis of the flow splitting column is 7 to 8 mm away from the jet port at the top end of the micro mixing tank, and the flow splitting column is located on the central axis of the splayed flow baffle plate.

Preferably, the length of the micro mixing tank is 2 to 4 times the length of the corresponding central axis between the top end of the splayed flow baffle plate and the flow splitting column in the micro mixing tank.

Preferably, two sides of the bottom of the micro mixing tank are in form of a symmetrical U-shaped or V-shaped wall surface structure.

Preferably, a jet port of a downstream micro mixing tank is directly arranged on an outlet of an upstream micro mixing tank as a contraction section, thereby realizing the multistage series connection of each micro mixing tank.

Preferably, the fluid inlet includes a first fluid inlet and a second fluid inlet.

Based on another objective of the present invention, the present invention proposes a fluid mixing method using the above multistage series microreactor, including:

injecting two fluids, through the fluid inlet, into the fluid passage to collect the two fluids into one stream of mixed fluid, wherein the mixed fluid is sprayed, through the jet port, into the micro mixing tank to collide at a high speed with the splayed flow baffle plate and the flow splitting column, so that the mixed fluid is crushed in an accelerate manner and is split into two parts; then the two parts are transversely collided and mixed along the wall surface at the bottom of the micro mixing tank and then are collected again at the jet port and jetted into the next micro mixing tank; and the fluid, after being repeatedly split, merged and recombined by a plurality of serially connected micro mixing tanks and jet ports, is led out through the fluid outlet. Therefore, higher mixing effect at a low pressure drop is achieved, and meanwhile, the coalescence of multiphase fluids caused by vortex is avoided. This fluid mixing method is particularly suitable for mixing and mass transfer of multiphase fluids. In the present invention, the splayed flow baffle plate and the flow splitting column divide the sprayed fluid into two parts, thereby reducing the diffusion distance of the fluid.

Preferably, the multistage series microreactor is used in series and/or in parallel to realize efficient mixing and continuous reaction of more fluids.

The present invention further includes other components capable of making a multistage series microreactor to be normally used, which are all conventional means in the art. In addition, devices or components and the like which are not limited in the present invention all adopt the prior art in the field.

Compared with the prior art, the present invention has the following beneficial effects: according to the present invention, by means of a jet manner, a fluid to be mixed is continuously split, compounded, stretched and crushed, so that the contact area is increased, the uniform distribution performance of fluids is improved, and the mixing process of fluids is enhanced, thereby realizing rapid mixing and efficient, continuous reaction.

### BRIEF DESCRIPTION OF DRAWINGS

FIG. 1 is an overall structural schematic diagram of the present invention in Example 1.

FIG. 2 is a partially enlarged schematic diagram at A in FIG. 1.

FIG. 3 is a schematic diagram of cross-sectional shapes of a splayed flow baffle plate and a flow splitting column.

FIG. 4 is a schematic diagram of cross-sectional shapes of a splayed flow baffle plate and a flow splitting column.

FIG. 5 is a schematic diagram of a fluid mixing process flow.

Reference numerals: 1—base, 2—first fluid inlet, 3—second fluid inlet, 4—splayed flow baffle plate, 5—flow splitting column, 6—micro mixing tank, 7—jet port, B—distance between the top end of the splayed flow baffle plate and the bottom end of the flow splitting column, C—length of the micro mixing tank, D—wall surface structure, E—distance between the central axis of the splayed flow baffle plate and the top end of the baffle plate, F—distance between the central axis of the splayed flow baffle plate and the bottom end of the baffle plate, G—distance between the top end of the splayed flow baffle plate and a jet port at the top end of the micro mixing tank.

### DETAILED DESCRIPTION

The technology of the present invention will be further described in detail below in conjunction with the accompanying drawings and specific examples.

### Example 1

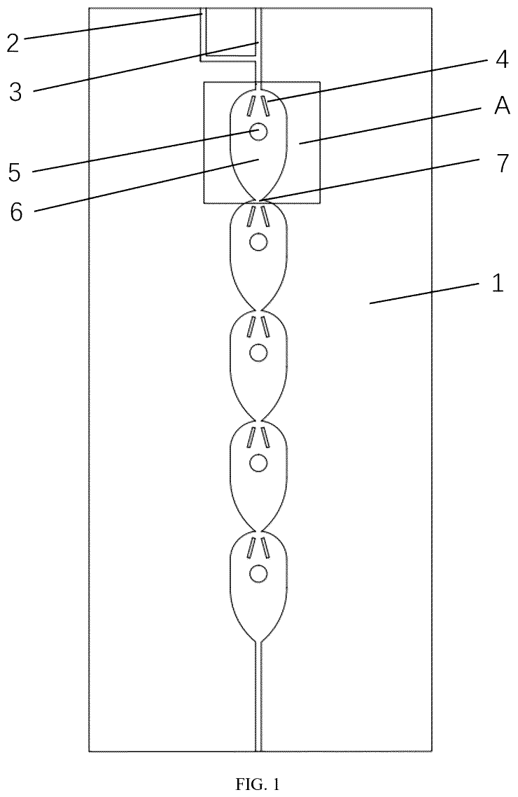

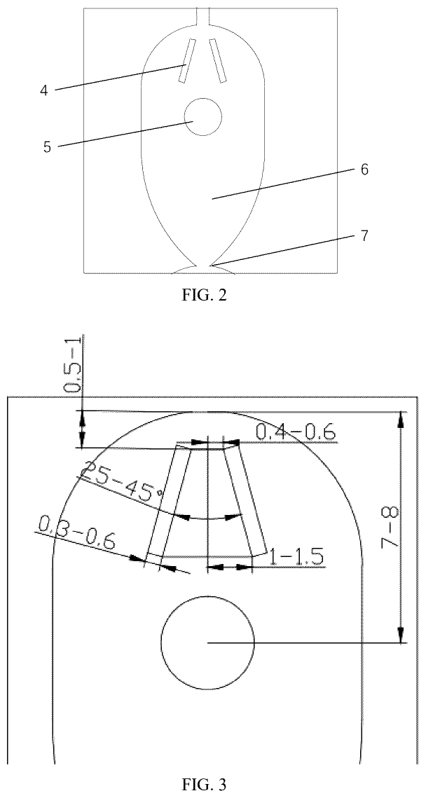

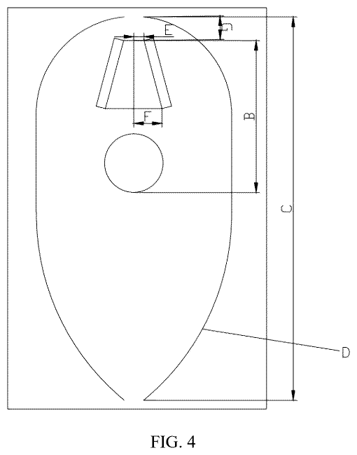

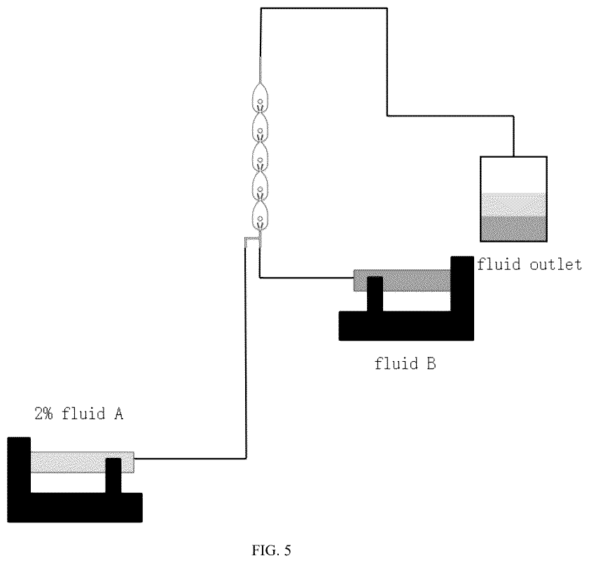

As shown in FIGS. 1 to 3, a multistage series microreactor proposed in this example includes a base 1 internally etched with a fluid passage, the base being provided with a fluid inlet and a fluid outlet which are communicated with the fluid passage, where the fluid inlet includes a first fluid inlet 2 and a second fluid inlet 3, the fluid passage includes five micro mixing tanks 6, adjacent micro mixing tanks are connected by a jet port, a jet port 7 is formed at an inlet of the micro mixing tank, and a splayed flow baffle plate 4 and a flow splitting column 5 which are arranged corresponding to the jet port are provided in the micro mixing tank, the flow splitting column being arranged below the splayed flow baffle plate, the number of the splayed flow baffle plate in each micro mixing tank being one pair. Two sides of the bottom of the micro mixing tank D are in form of a symmetrical U-shaped wall surface structure, so that the fluid is compounded at the jet port 7 of the micro mixing tank.

In this example, a jet port at the top end of a downstream micro mixing tank is directly arranged on a jet port at the bottom end of an upstream micro mixing tank as a contraction section, thereby realizing the multistage series connection of each micro mixing tank.

Specifically, in each micro mixing tank, the top end of the splayed flow baffle plate is 0.6 mm away from a jet port at the top end of the micro mixing tank and has an opening angle of 30 degrees, the jet port being located on a central axis of the splayed flow baffle plate. More specifically, the splayed flow baffle plate includes two baffle plates which are bilaterally symmetrical along the central axis of the splayed flow baffle plate, and the baffle plates are rectangular in cross section; the baffle plate has a width of 0.5 mm and a length of 3.6 mm, and the central axis of the splayed flow baffle plate is 0.52 mm away from the top end of the baffle plate and 1.44 mm away from the bottom end of the baffle plate.

More specifically, the flow splitting column is cylindrical and has a diameter of 3 mm; in each micro mixing tank, an axis of the flow splitting column is 7.48 mm away from the jet port at the top end of the micro mixing tank, and the flow splitting column is located on the central axis of the splayed flow baffle plate. The length of the micro mixing tank is 2.6 times the length of the corresponding central axis between the top end of the splayed flow baffle plate and the bottom end of the flow splitting column in the micro mixing tank.

This example further proposes a fluid mixing method, as shown in FIGS. 5, the fluid mixing process includes:

injecting two fluids, through the fluid inlet, into the fluid passage to collect the two fluids into one stream of mixed fluid, where the mixed fluid is sprayed, through the jet port, into the micro mixing tank to collide at a high speed with the splayed flow baffle plate and the flow splitting column, so that the mixed fluid is crushed in an accelerate manner and is split into two parts; then the two parts are transversely collided and mixed along the wall surface at the bottom of the micro mixing tank and then are collected again at the jet port and jetted into the next micro mixing tank; and the fluid, after being repeatedly split, merged and recombined by five serially connected micro mixing tanks and jet ports, is led out through the fluid outlet. Therefore, higher mixing effect at a low pressure drop is achieved, and meanwhile, the coalescence of multiphase fluids caused by vortex is avoided. This fluid mixing method is particularly suitable for mixing and mass transfer of multiphase fluids.

The splayed flow baffle plate and the flow splitting column split the sprayed fluid into two parts, thereby reducing the diffusion distance of the fluid.

### Example 2

The only difference between this example and Example 1 is that: in each micro mixing tank, the splayed flow baffle plate is 0.5 mm away from a jet port at the top end of the micro mixing tank and has an opening angle of 25 degrees, the baffle plate has a width of 0.3 mm and a length of 3 mm, and the central axis of the splayed flow baffle plate is 0.4 mm away from the top end of the baffle plate and 1 mm away from the bottom end of the baffle plate. The flow splitting column has a diameter of 2.5 mm, and an axis of the flow splitting column is 7 mm away from the jet port at the top end of the micro mixing tank. The length of the micro mixing tank is 2 times the length of the corresponding central axis between the top end of the splayed flow baffle plate and the flow splitting column in the micro mixing tank.

### Example 3

The only difference between this example and Example 1 is that: in each micro mixing tank, the splayed flow baffle plate is 0.8 mm away from a jet port at the top end of the micro mixing tank and has an opening angle of 35 degrees, the baffle plate has a width of 0.4 mm and a length of 4.5 mm, and the central axis of the splayed flow baffle plate is 0.5 mm away from the top end of the baffle plate and 1.3 mm away from the bottom end of the baffle plate. The flow splitting column has a diameter of 3.2 mm, and an axis of the flow splitting column is 7.6 mm away from the jet port at the top end of the micro mixing tank. The length of the micro mixing tank is 3 times the length of the corresponding central axis between the top end of the splayed flow baffle plate and the flow splitting column in the micro mixing tank.

### Example 4

The only difference between this example and Example 1 is that: in each micro mixing tank, the splayed flow baffle plate is 0.9 mm away from a jet port at the top end of the micro mixing tank and has an opening angle of 40 degrees, the baffle plate has a width of 0.45 mm and a length of 5 mm, and the central axis of the splayed flow baffle plate is 0.56 mm away from the top end of the baffle plate and 1.4 mm away from the bottom end of the baffle plate. The flow splitting column has a diameter of 3.4 mm, and an axis of the flow splitting column is 7.8 mm away from the jet port at the top end of the micro mixing tank. The length of the micro mixing tank is 3.5 times the length of the corresponding central axis between the top end of the splayed flow baffle plate and the flow splitting column in the micro mixing tank.

### Example 5

The only difference between this example and Example 1 is that: in each micro mixing tank, the splayed flow baffle plate is 1 mm away from a jet port at the top end of the micro mixing tank and has an opening angle of 45 degrees, the baffle plate has a width of 0.6 mm and a length of 6 mm, and the central axis of the splayed flow baffle plate is 0.6 mm away from the top end of the baffle plate and 1.5 mm away from the bottom end of the baffle plate. The flow splitting column has a diameter of 3.5 mm, and an axis of the flow splitting column is 8 mm away from the jet port at the top end of the micro mixing tank. The length of the micro mixing tank is 4 times the length of the corresponding central axis between the top end of the splayed flow baffle plate and the flow splitting column in the micro mixing tank.

### Comparative Example 1

The only difference between this comparative example and Example 1 is that: in each micro mixing tank, the splayed flow baffle plate is 0.4 mm away from a jet port at the top end of the micro mixing tank and has an opening angle of 20 degrees, the baffle plate has a width of 0.2 mm and a length of 2 mm, and the central axis of the splayed flow baffle plate is 0.3 mm away from the top end of the baffle plate and 0.8 mm away from the bottom end of the baffle plate. The flow splitting column has a diameter of 2 mm, and an axis of the flow splitting column is 6 mm away from the jet port at the top end of the micro mixing tank. The length of the micro mixing tank is 1.8 times the length of the corresponding central axis between the top end of the splayed flow baffle plate and the flow splitting column in the micro mixing tank.

### Comparative Example 2

The only difference between this comparative example and Example 1 is that: in each micro mixing tank, the splayed flow baffle plate is 1.5 mm away from a jet port at the top end of the micro mixing tank and has an opening angle of 50 degrees, the baffle plate has a width of 0.8 mm and a length of 7 mm, and the central axis of the splayed flow baffle plate is 0.8 mm away from the top end of the baffle plate and 1.8 mm away from the bottom end of the baffle plate. The flow splitting column has a diameter of 4 mm, and an axis of the flow splitting column is 9 mm away from the jet port at the top end of the micro mixing tank. The length of the micro mixing tank is 4.5 times the length of the corresponding central axis between the top end of the splayed flow baffle plate and the flow splitting column in the micro mixing tank.

### Comparative Experiment:

The multistage series microreactors described in Examples 1 to 5 and Comparative Examples 1 and 2 were respectively adopted to mix water and kerosene-benzoic acid at different flow rates in a ratio of 1:1, and the total volume mass transfer coefficients were calculated according to the concentration difference of benzoic acid at the inlet and the outlet, so as to determine how the reactor performance is.

Experimental results are shown in the following table:

| | | | | | | | |
|---|---|---|---|---|---|---|---|
| Total Volume Mass | Example 1 | 4.8217 | 7.1147 | 7.8817 | 9.4284 | 61.410 | 129.749 |
| Transfer | Example 2 | 4.5874 | 6.9872 | 7.8032 | 8.3974 | 60.973 | 125.504 |
| Coefficients | Example 3 | 4.4328 | 7.1009 | 7.8647 | 9.3854 | 60.287 | 123.792 |
| | Example 4 | 4.3728 | 6.9538 | 7.8167 | 8.5538 | 59.327 | 119.367 |
| | Example 5 | 4.2654 | 6.8526 | 7.8089 | 8.3827 | 58.967 | 117.843 |
| | Comparative | 3.9872 | 6.5219 | 6.7738 | 7.9356 | 58.1387 | 116.3864 |
| | Example 1 | | | | | | |
| | Comparative | 3.8854 | 6.3874 | 6.5794 | 7.8748 | 57.6632 | 115.9873 |
| | Example 2 | | | | | | |

The experimental results described above show that the multistage series microreactors proposed in the examples of the present invention all have higher total volume mass transfer coefficients and more excellent reactor performance at different flow rates compared with the comparative examples and the prior art.

The above description is merely preferred examples of the present invention and is not intended to limit the present invention. Any modification, equivalent substitution, improvement or the like made within the spirit and principle of the present invention shall be included within the protection scope of the present invention.

What is claimed is:

1. A multistage series microreactor, comprising a base internally etched with a fluid passage, the base being provided with a fluid inlet and a fluid outlet which are communicated with the fluid passage, wherein the fluid passage comprises a plurality of micro mixing tanks, a jet port is formed at an inlet of the micro mixing tank, adjacent micro mixing tanks are connected by the jet port, and a splayed flow baffle plate and a flow splitting column which are arranged corresponding to the jet port are provided in the micro mixing tank, the flow splitting column being arranged below the splayed flow baffle plate.

2. The multistage series microreactor according to claim 1, wherein in each micro mixing tank, the number of the splayed flow baffle plate is one pair, the splayed flow baffle plate is 0.5 to 1 mm away from a jet port at the top end of the micro mixing tank and has an opening angle of 25 to 45 degrees, the jet port being located on a central axis of the splayed flow baffle plate.

3. The multistage series microreactor according to claim 2, wherein the splayed flow baffle plate comprises two baffle plates which are bilaterally symmetrical along the central axis of the splayed flow baffle plate, and the baffle plates are rectangular in cross section; the baffle plate has a width of 0.3 to 0.6 mm and a length of 3 to 6 mm; in each micro mixing tank, the central axis of the splayed flow baffle plate is 0.4 to 0.6 mm away from the top end of the baffle plate and 1 to 1.5 mm away from the bottom end of the baffle plate.

4. The multistage series microreactor according to claim 3, wherein the flow splitting column is cylindrical and has a diameter of 2.5 to 3.5 mm; in each micro mixing tank, an axis of the flow splitting column is 7 to 8 mm away from the jet port at the top end of the micro mixing tank, and the flow splitting column is located on the central axis of the splayed flow baffle plate.

5. The multistage series microreactor according to claim 4, wherein the length of the micro mixing tank is 2 to 4 times the length of the corresponding central axis between the top end of the splayed flow baffle plate and the flow splitting column in the micro mixing tank.

6. The multistage series microreactor according to claim 1, wherein two sides of the bottom of the micro mixing tank are in form of a symmetrical U-shaped or V-shaped wall surface structure.

7. The multistage series microreactor according to claim 1, wherein a jet port of a downstream micro mixing tank is directly arranged on an outlet of an upstream micro mixing tank as a contraction section, thereby realizing the multistage series connection of each micro mixing tank.

8. The multistage series microreactor according to claim 1, wherein the fluid inlet comprises a first fluid inlet and a second fluid inlet.

9. A fluid mixing method using the multistage series microreactor according to claim 1, comprising:
injecting two fluids, through the fluid inlet, into the fluid passage to collect the two fluids into one stream of mixed fluid, wherein the mixed fluid is sprayed, through the jet port, into the micro mixing tank to collide at a high speed with the splayed flow baffle plate and the flow splitting column, so that the mixed fluid is crushed in an accelerate manner and is split into two parts; then the two parts are transversely collided and mixed along the wall surface at the bottom of the micro mixing tank and then are collected again at the jet port and jetted into the next micro mixing tank; and the fluid, after being repeatedly split, merged and recombined by a plurality of serially connected micro mixing tanks and jet ports, is led out through the fluid outlet.

10. The fluid mixing method according to claim 9, wherein the multistage series microreactor is used in series and/or in parallel.
